(19) United States
(12) Patent Application Publication
(10) Pub. No.: US 2013/0209689 A1
(43) Pub. Date: Aug. 15, 2013

(54) Sulfonation of Plastic and Composite Materials

(71) Applicants: Mark Wojtaszek, Canton, CT (US); Robert Hamilton, Torrington, CT (US); John Wallace, Bloomfield Village, MI (US); Bradlee Radke, Roseville, MI (US)

(72) Inventors: Mark Wojtaszek, Canton, CT (US); Robert Hamilton, Torrington, CT (US); John Wallace, Bloomfield Village, MI (US); Bradlee Radke, Roseville, MI (US)

(21) Appl. No.: 13/396,814

(22) Filed: Feb. 15, 2012

(51) Int. Cl. B05D 3/10; B05D 3/04

(52) U.S. Cl. 427/305; 427/304

(57) ABSTRACT

A method of preparing a plastic article to accept plating thereon is proposed. At least a portion of the plastic article is rendered plateable by sulfonation. The method includes the steps of: (a) exposing the plastic article to an atmosphere containing a sulfonating agent to sulfonate at least a portion of the plastic article; (b) conditioning the sulfonated article with an alkaline conditioner; (c) activating the plastic article with an ionic palladium activator; and (d) contacting the plastic article with an accelerator to react with adsorbed palladium increase the catalytic activity of at least the portion of the plastic article.

### FIELD OF THE INVENTION

The present invention relates generally to the sulfonation of plastic and composite materials to increase adhesion thereon.

### BACKGROUND OF THE INVENTION

In recent years plating of plastics has become of ever increasing importance. In order to provide plastics with firmly bonded metal coatings, the plastic material must be modified so as to accept a metallic plating thereon. It is well known in the art that electroplated or electroless metal coatings will not bond or adhere to plastic or elastomeric materials unless the surfaces of these materials are first suitably prepared.

The process for a typical prior art plating on plastics cycle typically involves the following steps:

(1) etching the substrate;

(2) neutralizing the etched surface;

(3) catalyzing the neutralized surface;

(4) immersion in an accelerator solution, which is either an acid or a base; and

(5) forming a metallic coating on the activated substrate.

In this process, the etchant is a solution containing chromium trioxide, such as chromic acid, or mixed acid combinations of the chromic/sulfuric or chromic/sulfuric/phosphoric types. These strongly oxidizing solutions micro-roughen and chemically alter the surface of the plastic materials by forming polar organic functional groups such as R—SO₃—H, R—CO₂—H and R—CH═. The presence of these polar groups promotes adsorption of plating catalysts from aqueous solutions which allows subsequent metal deposition to readily occur.

There are two main disadvantages of using solutions containing chromium trioxide. First, the concentration of these solutions must be controlled within a predetermined narrow range or else during the subsequent plating step, the plastic surface will either be plated non-uniformly or fully plated with a coating of inadequate bond strength. A further disadvantage relates to the removal and detoxification of hexavalent chromium compounds from these solutions. In an effort to avoid these problems, treating solutions based on alternate chemicals have been sought.

For example, surface modification of polymers, such as by sulfonation, can be used for improving polymer properties by changing the hydrophobic surfaces to hydrophilic surfaces. Sulfonation can be achieved using several methods, including treatment with vapor phase sulfur trioxide, hot concentrated sulfuric acid, and fuming sulfuric acid, among others. Sulfonation alters the chemical structure of a polymeric substrate by introducing sulfonic groups on its surface region. Sulfonation processes for modifying surfaces of plastics to accept plating thereon are described for example in U.S. Pat. No. 4,520,046 to McCaskie, U.S. Pat. No. 5,958,509 to Neumann, U.S. Pat. No. 4,039,714 to Roubal, and U.S. Pat. No. 4,308,301 to Huss, the subject matter of each of which is herein incorporated by reference in its entirety. The process of treating the surface region with sulfur trioxide gas and various neutralization agents to modify the molecular structure of the surface region of the plastic can be effective on a wide variety of polymers.

In the sulfonation process, SO₃ bonds to the carbon atoms present in the polymers and forms C—SO₃H. Essentially all commercially available plastics and films contain either a CH or an NH bond and are treatable via sulfonation, although sulfonation may proceed at different rates depending on the particular polymer resin being sulfonated. For NH containing materials, N—SO₃H results as opposed to C—SO₃H.

While various sulfonation processes have been developed for treating plastic substrates, further improvements are still needed to obtain a treated plastic surface upon which a uniform and highly adherent metal coating may be deposited.

### SUMMARY OF THE INVENTION

It is an object of the present invention to provide a process for treating or preparing the surface of a plastic or elastomeric material to accept a uniform and highly adherent metal coating thereon.

It is another object of the present invention to provide a process for metal plating plastic or elastomeric materials which utilizes an improved surface preparation treatment.

To that end, in one embodiment, the present invention relates generally to a method of preparing a plastic article to accept plating thereon, wherein at least a portion of the plastic article is rendered plateable by sulfonation, the method comprising the steps of:

exposing the plastic article to an atmosphere or environment containing a sulfonating agent to sulfonate at least a portion of the plastic article;

b) contacting the sulfonated plastic article with a conditioner, which is preferably alkaline, to improve the adsorption of subsequently applied activator;

c) contacting the plastic article with an ionic noble metal activator such that noble metal is adsorbed to the surface of the plastic article;

d) contacting the plastic article with an accelerator to react with adsorbed noble metal to thereby increase the catalytic activity of adsorbed noble metal towards plating; and

e) contacting the plastic article with an electroless metal plating bath.

### DETAILED DESCRIPTION OF THE PREFERRED EMBODIMENTS

The present invention relates generally to a process of preparing a surface of a plastic (including composite plastic) article to accept a metallic coating thereon by sulfonation as described herein. Sulfonation makes certain polymers polar so that precious metal catalysts in a subsequent catalyzing (activating) step can be made to adhere (adsorb) to the polymer surface.

In one embodiment, the present invention relates generally to a method of preparing a plastic article to accept plating thereon, wherein at least a portion of the plastic article is rendered plateable by sulfonation, the method comprising the steps of:

a) exposing the plastic article to an atmosphere (environment) containing a sulfonating agent to sulfonate at least a portion of the plastic article;

b) contacting the sulfonated plastic article with a conditioner, which is preferably alkaline, to improve the adsorption of subsequently applied activator;

c) contacting the plastic article with an ionic noble metal activator such that noble metal is adsorbed to the surface of the plastic article; and

d) contacting the plastic article with an accelerator to react with adsorbed noble metal to thereby increase the catalytic activity of the adsorbed noble metal towards plating; and

e) contacting the plastic article with an electroless metal plating bath.

The plastic article may be plated in an electroless plating bath so that at least the portion of the plastic article rendered plateable by sulfonation is electrolessly plated. While various metals can be electrolessly plated in accordance with the present invention, in a preferred embodiment, the electroless plating bath comprises electroless nickel or electroless copper. Finally, the plastic article may also be electroplated to deposit additional layers on top of the electroless nickel or electroless copper layer.

In addition, optionally, but preferably, water rinses are interspersed between each of steps a) through e).

Various sulfonating agents may be used in the practice of the invention, including fuming sulfuric acid or vapor phase sulfur trioxide. More preferably, the sulfonating agent comprises vapor phase sulfur trioxide. The sulfur trioxide containing atmosphere, as it is used for chemical conditioning of plastic materials, comprises a gas which does not enter into reaction with sulfur trioxide. Preferably the carrier gas is air, but other gases may also be used for this purpose, including for example, oxygen, nitrogen, carbon dioxide, noble gases, and other gases meeting the requirement of non-reactivity with sulfur trioxide.

Conditioning time, temperature, and sulfur trioxide concentration in the conditioning gas are dependent upon the type of plastic material to be treated. Thus, on the one hand, shorter conditioning times coupled with higher sulfur trioxide concentration or, higher temperatures of the conditioning atmosphere and, on the other hand, longer conditioning time coupled with a lower sulfur trioxide concentration or a lower conditioning temperature will yield like results.

In a preferred embodiment, the plastic article comprises a material selected from the group consisting of poly(ether-ether-ketone) (PEEK) resins, amorphous thermoplastic polyetherimide (PEI) resins (such as Ultem resins, available from Sabic Innovative Plastics, Pittsfield, Mass.), polyphenylene sulfide (PPS) resin, thermoplastic olefin (TPO) resins, polyamide (including PAG, PA6,6 PA12), polyethylene, polypropylene polyarylamide (PAA), polypthalamide (PPA), polyacetal, polybutadine teraphthalate (PBT), polyethylene teraphthalate (PET), acrylonitrile-butadiene-styrene (ABS), acrylonitrile-styrene-acrylonitrile (ASA), polyurethane, and combinations of one or more of the foregoing, by way of example and not limitation. More preferably, at least a portion of the plastic article comprises polyethylene.

Upon completion of the sulfonation step, the final surface of the plastic article has hydroxyl and sulfonate groups, which allows for wetting and chemical bonding of the plastic surface and thus strong adhesion for subsequent electroless plating on the surface.

As set forth herein, the plastic article is rendered plateable without using a chromic acid etching step. In other words, the use of a sulfonation process for preparing the plastic article for plating means that a chromic acid etchant is not necessary to provide a surface that is plateable by electroless plating as described herein.

In addition, there is an operating window for this surface activation step during Which satisfactory results may be achieved. Insufficient treatment of the plastic substrate yields insufficient wetting, while excessive treatment of the plastic or composite substrate can cause charring and surface degradation. For example, depending on the plastic being treated, the plastic article may be contacted with the sulfonating agent for between about 1 second and about 60 minutes.

Furthermore, both the time of sulfonation of the substrate and the percentage of SO₃ in the gas mix are important. The percentage of SO₃ in the gas mix is controlled to within about 2 to about 16 weight percent, more preferably about 5 to about 15 weight percent.

The temperature of the conditioning atmosphere is also of importance for achieving satisfactory conditioning results, and temperatures of between about 24 and 35° C. are generally preferred. The sulfur trioxide concentration and the duration of treatment must be adjusted with respect to each other and can readily be determined by one skilled in the art.

The concentration range of the sulfur trioxide, the conditioning temperature and its duration, and humidity conditions are selected in accordance with the different chemical structure and reactivity of the known plastics and in such a manner that optimum conditioning of the plastic surface and complete coating with the metal plated thereon are achieved. The amount of water contained with the treating gas or gas carrier (air) is important, and should generally be between 0 to 0.125%. The dewpoint should be −50 to −100° F.

Treatment of the plastic or composite substrate can be detected by surface tension measurements and/or by FT-IR. In a preferred embodiment, the surface tension is preferably between about 32 dyne and about 60 dyne, in addition, optionally, but preferably, blended plastic materials should be selected to have overlapping treatment windows. For example, blended plastics such as polyacetal and polyethylene or acrylonitrile-butadiene-styrene may be sulfonated by the process described herein. Different polymers have differing degrees of resistance to the sulfonation reaction, and have different percentages of sites which can be sulfonated at all. Therefore, different treatment times and conditions are necessary to yield usable surface tensions.

As discussed above, a typically chromic acid etch cycle comprises the following steps:

1) Chromic etch

2) Rinses

3) Neutralizer

4) Rinses

5) Activator Predip

6) Activator

7) Rinses

8) Accelerator

9) Rinses

10) Copper or nickel plate

In contrast, the process for treating the surface of a plastic material in accordance with the present invention comprises:

1) Sulfonation

2) SA conditioner

3) Rinses

4) SA activator

5) Rinses

6) SA accelerator

7) Rinses

8) Copper or nickel plate

After being contacted with the atmosphere containing the sulfonating agent in the manner described above for a sufficient period of time and under suitable processing conditions to sulfonate at least a portion of the plastic article, the plastic article is next treated with a conditioner to improve catalysation. Such conditioners typically comprise alkaline mixtures of surfactants and/or silanes which improve the adsorption of the subsequently applied activator to the surface of the plastic part. The alkaline conditioner is typically a solution of a suitable non-ionic surfactant in an alkaline cleaner. In a preferred embodiment, the alkaline conditioner comprises about 8 to 12 percent by volume, more preferably about 10 percent by volume of the Macuplex SA Conditioner Part A and 5 percent by volume Macuplex SA Conditioner Part B, in water.

The use of the alkaline conditioner permits additional advantages such as a broader operating range of sulfonation, a broader list of permissible plastics that can be treated with good results, better adhesion to the plastic surface, and other similar improvements. The conditioner treatment promotes adsorption of the catalyst by interacting with the surface of the sulfonated plastic.

In a preferred embodiment, the alkaline conditioner comprises a solution of MacuPlex SA conditioner Part A. and MacuPlex SA conditioner Part B (available from MacDermid, Inc., Waterbury Conn.). Other suitable alkaline conditioners are also usable in the practice of the invention. The alkaline conditioner is preferably maintained at a temperature of between about 57-62° C. (135-145° F.), and the plastic article is contacted with the alkaline conditioner, preferably by immersion, for a contacting time sufficient to improve catalysation of the plastic article, which in one embodiment may be between about 1 to 5 minutes.

Thereafter, the conditioned substrate is contacted with an activator, which preferably comprises an ionic palladium solution and not a colloidal catalyst. Regarding the types of noble metal ionic catalysts that are useful in the activation step of the process of the present invention, noble metals provide the best results, including for example palladium, platinum, silver or gold, as well as other known noble metals. In a preferred embodiment, the metal is palladium and the activator comprises a complexed ionic palladium activator, which may be either an alkaline solution or an acid solution.

In a first embodiment, an alkaline solution of the ionic palladium activator is used comprising a solution of about 6-9% by volume, more preferably about 7.5% by volume of Macuplex SA Activator Part A and about 0.1 percent by volume of Macuplex SA activator Part B. In a preferred embodiment, the ionic palladium activator comprises MacuPlex SA Activator, Part A and Part B. (available from MacDermid, Inc., Waterbury Conn.). Other suitable ionic activators are also usable in the practice of the invention. The solution is typically maintained at a of about 10.0 to 11.5, more preferably at about 11.0 and the temperature of the solution in the treatment tank is maintained at about 41-46′C (105-115° F.). The plastic article is contacted with the ionic palladium activator, preferably by immersion, for a contacting time of about 1 to 6 minutes, more preferably about 4 minutes.

In an alternative preferred embodiment, an acid solution of the ionic palladium activator is used comprising a solution of about 1-3% by volume, more preferably about 2.5% by volume of Macuplex Infinity Activator MP. In a preferred embodiment, the ionic palladium activator comprises MacuPlex Infinity Activator MP, (available from MacDermid, Inc., Waterbury Conn.). Other suitable activators are also usable in the practice of the invention. The solution is typically maintained at a pH of less than about 2. Again, the temperature of the solution in the treatment tank is maintained at about 41-46° C. (105-115° F.). The plastic article is contacted with the ionic palladium activator, preferably by immersion, for a contacting time of about 2 to 6 minutes.

In any case it is important that the activator comprise an ionic solution and not a colloidal metal.

The activator working solution is preferably maintained to provide a concentration of palladium ions in the bath of about 50 ppm. For the acid bath, 20% sulfuric acid is used to lower the pH and, alternatively, 50% sodium hydroxide solution is used to raise the pH as required for the alkaline bath.

The acidic activation solution typically comprises:

| | |
|---|---|
| chromic acid flakes | 2.0 g/L |
| sulfuric acid | 5.0 g/L |
| MacuPlex Infinity Activator MP | 2.5% by vol. |

The palladium concentration is preferably maintained using atomic absorption spectroscopy at 50 ppm palladium for the acid solution and 75 ppm palladium for the alkaline solution.

Next, the substrate is contacted with an accelerator that reacts with adsorbed activator to controllably increase the catalytic activity of the substrate. In one embodiment, the accelerator is MacuPlex SA Accelerator, available from MacDermid, Inc. In one embodiment, the accelerator comprises about 2.5 to 15 percent by volume, more preferably about 5 percent by volume of Macuplex SA Accelerator Part A and about 0.3 to 3 percent by volume, more preferably about 1.5 percent by volume of Macuplex SA Accelerator Part B. In a preferred embodiment, the accelerator comprises MacuPlex SA Accelerator Part A and/or MacuPlex SA Accelerator Part B (available from MacDermid, Inc., Waterbury Conn.). Other suitable activators are also usable in the practice of the invention. The solution is typically maintained at a pH of between about 5.0 and 6.5, more preferably a pH of about 6.0. The temperature of the solution in the treatment tank is maintained at about 38-60° C. (100-140° F.), and the plastic article is contacted with accelerator, preferably by immersion, for an immersion time of about 1 to 5 minutes, more preferably about 3 minutes. In another preferred embodiment, the accelerator comprises Macuplex SA Alkaline Accelerator (available from MacDermid, Inc., Waterbury Conn.). This is typically made at 1-6% by volume in water, and used at 100 to 130° F., at a pH of 13, for about 1 to 6 minutes. These accelerators are typically aqueous solutions of reducing agents such as hypophosphite hydrazaine, hydroxylamine, and borohydride.

The inventors of the present invention have found that because sulfonation of different polymer resins occurs at different rates under the same conditions, there is some degree of selectivity of sulfonation on an article made from multiple polymer resins or other resin composite materials. For example, while ABS and PC/ABS can be sufficiently sulfonated for plating purposes very readily, polycarbonate is relatively very difficult and slow to sulfonate.

Thus, in one embodiment, the present invention can be used to render portions of a double-shot or multiple-shot molded plastic article plateable while the remaining portions are not plateable so that the article can be selectively plated in a desired pattern. Furthermore, in order to prevent any electroless metal from plating onto the non-plateable portions, a catalytic poison compound can optionally be included in the non-plateable resin to retard the tendency of subsequently applied electroless plating chemistry to create a plated deposit on that portion containing the catalytic poison compound.

All known solutions for the chemical plating of copper, nickel, or other metals can be used for metal plating the conditioned plastic surfaces. In all instances a uniform continuous metal layer is deposited. Said layer has a surprisingly high adherence to the plastic surface also after it has been provided with the final plate.

The result is a plastic article that exhibits improved plating quality. Metal plating electrolessly occurs when the activated parts are immersed into a solution containing a metal salt, and a reducing agent. Complexing agents, stabilizers, and a buffer to control pH are also generally employed. Nickel or copper can be autocatalytically deposited onto the activated plastic or elastomeric part. The metal adsorbed on the surface acts as a catalyst to initiate deposition after which autocatalytic reduction of the metal occurs.

After the initial layer of copper or nickel is deposited, subsequent layers of metal can be plated from suitable standard metal electroplating baths such as copper, nickel, or chromium.

As noted above, after each step of the process, a thorough water wash or rinse is desirable to obtain a successfully deposited metal coating. Also, multiple water rinses, where practical, are recommended.

For the purposes of this invention, metal plating is used to include conventional electroplating, as well as the so called “electroless” plating processes (i.e., those processes for metal plating that do not use an applied electric current). The most common electroless process is the catalyzed chemical reduction method, and this is characterized by the selective reduction of metal ions at the surface of a catalyzed substrate which is immersed in an aqueous plating solution. This reduction continues to occur onto the substrate through the catalytic action of the deposit itself. The advantage of electroless plating over electrolytic electroplating is that a dense, virtually non-porous metal coating of uniform thickness is provided on all surfaces of the part regardless of its shape or geometry.

The plastic article may also contain conventional filler materials such as glass fibers, asbestos, other mineral fillers, sawdust, carbonaceous materials such as graphite, dyestuffs, pigments, etc. if desired. In addition, the plastic article may be molded or shaped into various shapes.

It is also to be understood that the following claims are intended to cover all of the generic and specific features of the invention described herein and all statements of the scope of the invention which as a matter of language might fall therebetween.

What is claimed is:

1. A method of preparing a plastic article to accept plating thereon, wherein at least a portion of the plastic article is rendered plateable by sulfonation, the method comprising the steps of:
a) exposing the plastic article to an atmosphere containing a sulfonating agent to sulfonate at least a portion of the plastic article;
b) contacting the sulfonated plastic article with a conditioner;
c) contacting the plastic article with an ionic noble metal activator such that noble metal is adsorbed on at least a portion of the surface of the plastic article;
d) d) contacting the plastic article with an accelerator to react with adsorbed palladium to thereby increase the catalytic activity of the adsorbed noble metal towards plating; and
thereafter plating at least the sulfonated portion of the article.

2. The method according to claim 1, wherein the sulfonated article is plated in an electroless plating bath, wherein at least the portion of the plastic article rendered plateable by sulfonation is electrolessly plated,

3. The method according to claim 2, wherein the electroless plating bath comprises nickel or copper.

4. The method according to claim 1, wherein the water rinses are interspersed between each of steps a) through d)

5. The method according to claim 1, wherein the plastic article comprises a material selected from the group consisting of poly(ether-ether-ketone) resins, amorphous thermoplastic polyetherimide resins, polyphenylene sulfide resin, thermoplastic olefin, polyamide, polyethylene, polypropylene, polyarylamide, polypthalamide, Polyacetal, PET, PBT, and combinations of one or more of the foregoing.

6. The method according to claim 1, wherein the sulfonating agent comprises fuming sulfuric acid or vapor phase sulfur trioxide,

7. The method according to claim 6, wherein the sulfonating agent comprises vapor phase sulfur trioxide.

8. The method according to claim 1, wherein the plastic article is rendered placable without using a chromic acid containing etching step.

9. The method according to claim 1, Wherein the plastic article is contacted with the sulfonating agent for between about 1 second and about 60 minutes.

10. The method according to claim 10, wherein the noble metal is selected from the group consisting of palladium, platinum, gold and silver.

11. The method according to claim 11, wherein the noble metal comprises palladium.
